(19) United States
(12) Patent Application Publication
(10) Pub. No.: US 2013/0022441 A1
(43) Pub. Date: Jan. 24, 2013

(54) METHOD AND APPARATUS FOR BULK TRANSPORT OF PROPPANT

(71) Applicants: Jim Uhryn, Nisku (CA); Gaylord Granrud, Williston, ND (US); Johnson Lu, Edmonton (CA)

(72) Inventors: Jim Uhryn, Nisku (CA); Gaylord Granrud, Williston, ND (US); Johnson Lu, Edmonton (CA)

(73) Assignee: THOR'S OIL PRODUCTS, INC., Williston, ND (US)

(21) Appl. No.: 13/475,421

(22) Filed: May 18, 2012

Related U.S. Application Data
(60) Provisional application No. 61/509,943, filed on Jul. 20, 2011.

(51) Int. Cl. B65G 3/00; B65D 90/54; B65D 88/56; B65D 88/12; B65D 90/04

(52) U.S. Cl. 414/812; 220/1.5; 220/1.6; 222/166; 141/311 R

(57) ABSTRACT

A method of bulk transport of proppant is disclosed comprising: transporting proppant in an intermodal transport container to a well site, the intermodal transport container having four vertical walls, a roof, and a base, defining an enclosed interior, the proppant being loosely disposed within the enclosed interior; and unloading at least a portion of the proppant through one or more gates in the intermodal transport container at the well site. An apparatus for bulk transport of proppant is also disclosed.

### TECHNICAL FIELD

This document relates to methods and apparatuses for bulk transport of proppant.

### BACKGROUND

Proppant is used in downhole fluid treatments such as fracturing operations, which involve the injection of fluid into the well at pressures sufficient to fracture the formation, followed by the injection of proppant into the fractures to hold the fractures open once the operation is finished.

Conventional transport of proppant from a manufacturer to a well site requires the use of one or more transloading facilities, wherein the proppant is transferred from one type of containment vessel to another. A common example of proppant transloading occurs when a bulk rail car empties a load of proppant into a silo, and the proppant in the silo is subsequently loaded into a pneumatic proppant truck for delivery to a well site.

### SUMMARY

A method of bulk transport of proppant is disclosed comprising: transporting proppant in an intermodal transport container to a well site, the intermodal transport container having four vertical walls, a roof, and a base, defining an enclosed interior, the proppant being loosely disposed within the enclosed interior; and unloading at least a portion of the proppant through one or more gates in the intermodal transport container at the well site.

An apparatus for bulk transport of proppant is also disclosed comprising: an intermodal transport container at a well site, the intermodal transport container having four vertical walls, a roof, and a base, defining an enclosed interior, proppant being loosely disposed within the enclosed interior; and one or more gates in the intermodal transport container for unloading the proppant.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a flow diagram illustrating a conventional method of intercontinental proppant transport incorporating two transloading stages.

FIG. 1A is a side elevation view illustrating conventional proppant transport bags.

FIG. 2 is a flow diagram illustrating a method of intercontinental bulk transport of proppant.

FIG. 3 is a flow diagram illustrating a method and apparatus of bulk transport of proppant using an intermodal transport container.

FIG. 4 is a flow diagram illustrating a method of bulk transport of proppant.

### DETAILED DESCRIPTION

Immaterial modifications may be made to the embodiments described here without departing from what is covered by the claims.

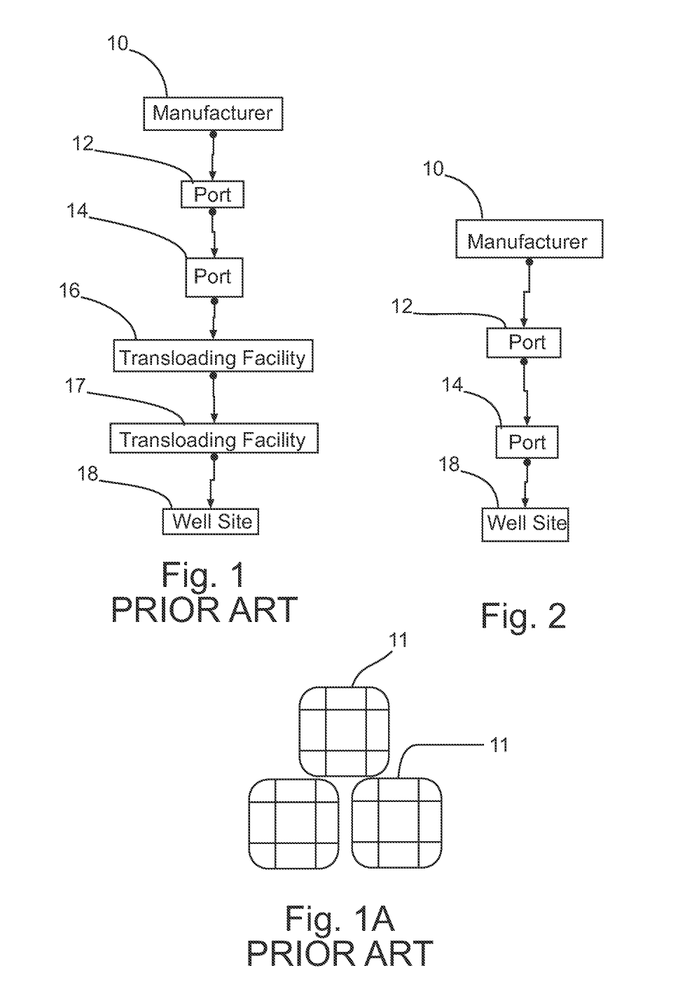

FIG. 1 illustrates a conventional method of transporting proppant to a well site 18. The manufacturer 10, for example a manufacturer of ceramic proppant located in China, manufactures and packages the proppant in bags 11 (FIG. 1A) for example containing 2000-3000 pounds of proppant each. The bags 11 may be stored at a warehouse in China awaiting shipment. Upon receipt of a purchase order, the manufacturer or distributor ships the bags 11 break bulk or in containers to a port 12, which is a port in China in this example. Generally, the bags 11 are made of rugged weatherproof material, especially if shipped break bulk. The bags 11 cross the ocean by boat and reach port 14, for example a port in the United States, where the bags 11 are stored or received at a first transloading facility 16. At this point, the bags 11 may be stored while awaiting the next stage, which is transloading the proppant from bags 11 into specialized bulk rail cars (not shown). Storage may also be required at this stage due to limited infrastructure required to load the specialized rail cars, or due to a limited amount of the rail cars themselves being present and ready to load.

Once loaded in the bulk rail cars, the proppant is transported by rail to a second transloading facility 17, where the proppant is transloaded from the bulk rail cars and placed into storage at the transloading facility 17 in a vertical silo or bin for example. Transloading from the rail car may be carried out by gravity feed from the base of the rail cars onto a conveyor into the facility 17, or by other suitable methods. Once in storage at the facility 17, the proppant is available for pickup by a customer for delivery to the well site. Pickup involves transferring the stored proppant into a proppant truck or tanker. Once loaded, the proppant truck then carries the proppant to the well site 18, where the proppant truck offloads the proppant by pneumatics into a blender or mountain mover for use in a downhole fluid treatment such as a fracturing operation.

The conventional method described above requires a large capital expenditure to acquire and operate the transloading facilities, the warehouse space at the port 14 and each transloading facility, and to acquire and operate the bulk rail cars, the pneumatic proppant trucks, and various other components required to make the system run smoothly. In addition, the complexity and limitations of each transloading stage add weeks and sometimes months to the transport of the proppant to the end user. Moreover, the conventional method requires efficient coordination of the various components in order to minimize delays, which are costly. For example, if facility 17 is not ready to receive the proppant on arrival of the rail cars, even a one to two day sitting period for the rail cars may carry substantial expenses that are passed on to the end user directly or indirectly.

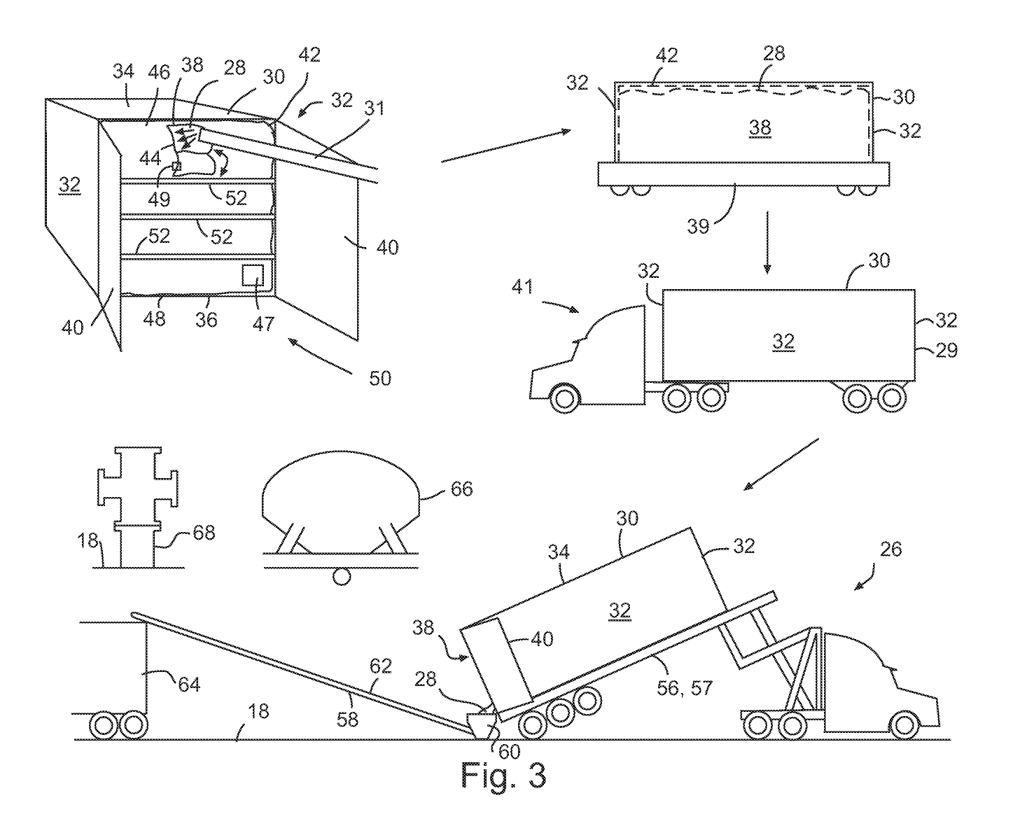

Referring to FIG. 3, an apparatus 26 of bulk transport of proppant 28 is illustrated, apparatus 26 comprising an intermodal transport container 30. The intermodal transport container 30 has four vertical walls 32, a roof 34, and a base 36. Walls 32, roof 34, and base 36 collectively define an enclosed interior 38. Proppant 28 is loosely disposed within the enclosed interior 38, for example so that the proppant 28 at least partially fills the enclosed interior 38 as shown. One or more gates, for example one or more rear gates 40, are provided in the intermodal transport container 30 for unloading the proppant 28. A rear wall 29 of the intermodal transport container 30 may define the one or more rear gates 40.

The intermodal transport container 30 may further comprise a liner 42, within the enclosed interior 38, that conforms to the four vertical walls 32, the roof 34, and the base 36. The liner 42 may be made of suitable materials such as plastic, and may be reusable. The liner 42 may be affixed, for example with webbing, adhesive, or other suitable mechanisms, to the roof 34 and base 36, and one or more of the walls 32 for stability. The liner 42 in combination with the intermodal transport container 30 may provide weather and moisture protection to the proppant 28. The liner 42 may have a port 44 in an upper portion 46 of the liner 42 for loading proppant 28 into the liner 42. A port 47 in a lower portion 48 of the liner 42 may be provided at a rear end 50 of the intermodal transport container 30 for unloading the proppant 28 from the liner 42. Both ports 44 and 47 may be re-sealable, for example using a zipper 49, ziplock, or other suitable sealing mechanism. Two or more rigid support members, such as steel pipes 52, may span the rear wall 29 in support of the liner 42 when the gates 40 are open. Pipes 52 brace the liner 42 from falling out rear end 50 of the intermodal transport container 30 during tilting of the intermodal transport container 30 as is described in further detail below. The rigid support members (pipes 52) may be oriented at suitable angles, such as horizontal or vertical, and may cross one another to form cross-braces.

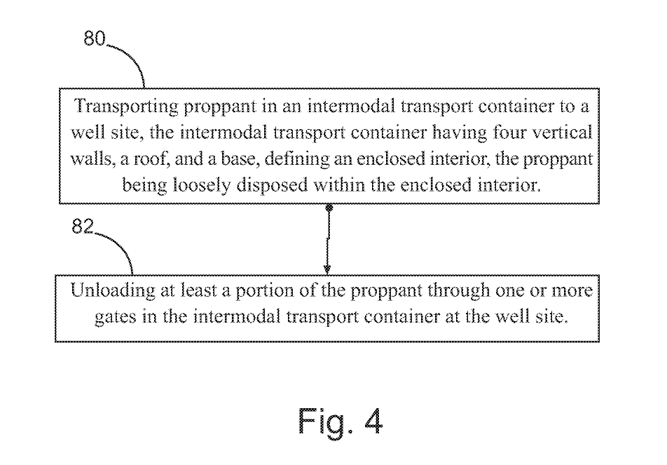

Referring to FIG. 4, a method of bulk transport of proppant is illustrated. Referring to FIGS. 2 and 3, the method of FIG. 4 will now be described. In a first stage 80 (shown in FIG. 4), proppant is transported loosely disposed within the enclosed interior 38 of intermodal container 30 to a well site 18. Transporting may further comprise transporting the proppant from one or more of ports 12, 14 (FIG. 2) or manufacturing facility 10, in the intermodal transport container 30. In other embodiments, the intermodal transport container 30 may be loaded at and transported from a transloading or storage facility 16 instead of using a pneumatic proppant truck. As described above, the proppant may be transported while being contained within liner 42. Thus, a manufacturer 10 or distributor (not shown) may ship the proppant loosely disposed in the intermodal transport container 30, without requiring the use of bags 11. The method may thus further comprise loading the proppant, for example with a conveyor 31, in the intermodal transport container 30 prior to transporting, although the loading stage may occur after the manufacturer stage, for example if the intermodal transport container 30 is loaded at a transloading station prior to transport out to well site 18. Transporting may further comprise one or more mode switches, for example from carriage by railcar 39 to tractor trailer 41, or from boat (not shown) to railcar 39.

In a second stage 82 (shown in FIG. 4), at least a portion of the proppant is unloaded through one or more gates, such as rear gates 40, in the intermodal transport container 30 at the well site 18. The well site 18 is understood to include the working area around the wellhead 68, and may include an area of land up to several kilometers away from the actual wellhead 68. Unloading may be carried out using a container tilter 56, such as a hydraulic fifth wheel tilter as shown, or by other suitable methods such as crane (not shown). Tilter 56 may be mounted on a wheeled trailer 57 as shown or as part of a skid (not shown). Unloading may be carried out in several stages. In a first phase, intermodal transport container 30 is held at zero elevation to allow product to flow. In a second phase the tilter 56 trailer is elevated to about 10 degrees to allow further flow. In a third phase tilter 56 is elevated to 20 degrees for further flow. In a final phase, the tilter 56 is elevated to 30 degrees for clean out and unloading all remaining product. Each phase may take five minutes or less. Unloading by container tilting has been found to be advantageous over pneumatic unloading in that container tilting is quicker and less hazardous to worker health in that less fine dust is produced. In addition, a pneumatic system may have difficulty unloading proppant, which is dense and hard to lift with pneumatics, whereas tilter 56 relies on gravity to unload and thus takes advantage of the high density of the proppant. Container tilter 56 also allows substantially all, if not all, of the proppant contained within intermodal transport container 30 to be unloaded. The tilter 56 may remain at well site 18. Proppant may be unloaded from intermodal transport container 30 into a proppant transfer device 58 positioned to receive, for example by gravity as shown, proppant unloaded from the one or more rear gates 40 of the intermodal transport container 30. Proppant transfer device 58 may comprise one or more of a hopper 60 and a conveyor 62. Hopper 60 may be dimensioned to receive proppant from two or more intermodal transport containers 30 at a time. A mountain mover 64, also called a sand king, may be connected to receive proppant from the proppant transfer device 58, the mountain mover 64 being provided to load one or more blenders 66 on site for mixing proppant into treatment fluids for injection downhole into a well 68 at the well site 18. The mountain mover 64 may be top loaded as shown, or loaded by another suitable method. Although proppant is shown in FIG. 3 as being unloaded into mountain mover 64 for further dispensing into the blender 66, the mountain mover 64 may be bypassed and proppant may be unloaded into blender 66, for example via a proppant transfer device 58, removing the need for the mountain mover 64 at all.

The method may further comprise storing the proppant in the intermodal transport container 30 before transporting the proppant to the well site 18. Because the proppant is already safely contained within enclosed interior 38, storage does not require further shelter from the elements, and can be carried out in a suitable location such as a field or warehouse until needed. The intermodal transport container 30 and proppant may also be stored at the well site 18, for example until the well 68 is ready for a fracturing operation. The flexibility and low cost of storage of the intermodal transport container 30 is in contrast with the difficulty and expense associated with storing proppant shipped by the conventional methods described above. Because the intermodal transport container 30 effectively forms a weather protected storage unit, little if any storage infrastructure is required, whereas proppant shipped by the conventional method described above may require silos, bins, transloading equipment, and covered warehouses. In addition, the expense of delay along the supply chain in the conventional method in the form of rail charges, storage fees at transloading sites, and other expenses related to the extra infrastructure required is avoided, with delay in the methods disclosed herein generating only expenses associated with locating and positioning the intermodal transport container 30 at a storage site suitable for container storage.

Referring to FIGS. 1 and 2, the disclosed method thus carries advantages over the conventional method. In addition, other advantages are realized. For example, one or more transloading steps may be removed from the process entirely. Removal of a transloading step means that all of the expense and infrastructure associated with the transloading step, such as the facility, the operating costs, worker's wages, and overhead, are no longer required. Removal of a transloading step also means that the risk of contaminating the proppant with external substances or other sizes and types of proppant is reduced. Overall shipment time from manufacturer to well site 18 is also reduced, due to the removal of the transloading stages. Although the methods of FIGS. 1 and 2 are intercontinental shipment examples, similar advantages are realized in an intracontinental shipment example, which can be envisioned by removing the port stages in the flow diagrams of FIGS. 1 and 2. Moreover, transporting proppant in intermodal transport containers 30 is more secure than transport in bags 11 (FIG. 1A), as intermodal transport containers 30 are more damage-resistant and weatherproof than bags 11, which may easily rip or leak. Bag rippage is especially an issue with break bulk shipping, although any instance of premature bag rippage can result in lost proppant, even if the rippage occurs during a transloading stage. Additionally, switching transport modes, for example from rail to truck or ship to truck, is cheaper, easier, and faster with intermodal transport containers 30 than is switching transport modes in the conventional method described above, since no container to container transfer occurs and because of the almost universality of intermodal transport infrastructure use at shipment hubs. As well, no scales, silos, or pneumatic trailers are needed to carry out the disclosed method.

Intermodal transport container 30 transport is also advantageous due to the commonality and low cost of intermodal transport containers 30. Examples of standard intermodal transport containers are illustrated below in Table 1. In some embodiments the intermodal transport container 30 has a standard size of eight feet in width, and twenty, forty, or forty-five feet in length, as containers having these dimensions are common. It should be understood that various other sizes and shapes of intermodal transport containers are envisioned within the scope of this document, and the dimensions illustrated in Table 1 are not intended to be limiting. Further examples of intermodal transport containers include air freight transport containers, which are generally smaller in size from the standard intermodal freight containers used primarily in the rail and ship industries.

TABLE 1
Examples of intermodal transport container dimensions and statistics

| | | 20′ container | | | 40′ container | | | 45′ high-cube container | | |
|---|---|---|---|---|---|---|---|---|---|---|
| | | Imperial | metric | | imperial | metric | | imperial | metric | |
| external | length | 20′ 0″ | 6.096 | m | 40′ 0″ | 12.192 | m | 45′ 0″ | 13.716 | m |
| dimensions | width | 8′ 0″ | 2.438 | m | 8′ 0″ | 2.438 | m | 8′ 0″ | 2.438 | m |
| | height | 8′ 6″ | 2.591 | m | 8′ 6″ | 2.591 | m | 9′ 6″ | 2.896 | m |
| interior | length | 18′ 10 5/16″ | 5.758 | m | 39′ 5 45/64″ | 12.032 | m | 44′ 4″ | 13.556 | m |
| dimensions | width | 7′ 8 19/32″ | 2.352 | m | 7′ 8 19/32″ | 2.352 | m | 7′ 8 19/32″ | 2.352 | m |
| | height | 7′ 9 57/64″ | 2.385 | m | 7′ 9 57/64″ | 2.385 | m | 8′ 9 15/16″ | 2.698 | m |
| door | width | 7′ 8⅛″ | 2.343 | m | 7′ 8⅛″ | 2.343 | m | 7′ 8⅛″ | 2.343 | m |
| aperture | height | 7′ 5¾″ | 2.280 | m | 7′ 5¾″ | 2.280 | m | 8′ 5 49/64″ | 2.585 | m |

| | | | | | | | | | | | | |
|---|---|---|---|---|---|---|---|---|---|---|---|---|
| Volume | 1,169 | ft³ | 33.1 | m³ | 2,385 | ft³ | 67.5 | m³ | 3,040 | ft³ | 86.1 | m³ |
| maximum gross mass | 52,910 | lb | 24,000 | kg | 67,200 | lb | 30,480 | kg | 67,200 | lb | 30,480 | kg |
| empty weight | 4,850 | lb | 2,200 | kg | 8,380 | lb | 3,800 | kg | 10,580 | lb | 4,800 | kg |
| net load | 48,060 | lb | 21,600 | kg | 58,820 | lb | 26,500 | kg | 56,620 | lb | 25,680 | kg |

A potential disadvantage of the disclosed method over the conventional method described above is infrastructure such as unloading equipment like the proppant transfer device 58, that may be present at the well site 18 in some cases. In addition, transport in an enclosed intermodal transport container 30 may be more expensive than transport in an open-topped proppant dump truck. Moreover, it may be more expensive for the manufacturer 10 itself to ship in lined intermodal transport containers 30. However, despite these potentially higher pinpoint expenses, the disclosed method may still result in an overall cost reduction over the conventional method described above, and the overall benefits in efficiency and speed may outweigh the potential disadvantages. In addition, in embodiments where a proppant transfer device 58 is used that can feed directly to the blender, no mountain mover 64 is required thus potentially reducing instead of increasing on-site expenses.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. A method of bulk transport of proppant comprising:
transporting proppant in an intermodal transport container to a well site, the intermodal transport container having four vertical walls, a roof, and a base, defining an enclosed interior, the proppant being loosely disposed within the enclosed interior; and
unloading at least a portion of the proppant through one or more gates in the intermodal transport container at the well site.

2. The method of claim 1 in which the intermodal transport container further comprises a liner, within the enclosed interior, that conforms to the four vertical walls, the roof, and the base.

3. The method of claim 1 in which transporting further comprises transporting the proppant from a port in the intermodal transport container.

4. The method of claim 1 in which transporting further comprises transporting the proppant from a manufacturing facility in the intermodal transport container.

5. The method of any claim 1 further comprising loading the proppant in the intermodal transport container prior to transporting.

6. The method of claim 1 further comprising loading the unloaded proppant into a blender and using the proppant in a downhole fluid treatment at the well site.

7. The method of claim 1 in which the one or more gates comprise one or more rear gates and proppant is unloaded using a container tilter.

8. The method of claim 1 in which unloading further comprises unloading the proppant into a proppant transfer device.

9. The method of claim 1 further comprising loading the at least a portion of the proppant unloaded from the intermodal transport container into a mountain mover with the proppant transfer device.

10. The method of claim 1 in which the proppant comprises ceramic proppant.

11. The method of claim 1 in which the intermodal transport container has a standard size of eight feet in width, and twenty, forty, or forty-five feet in length.

12. The method of claim 1 further comprising storing the proppant in the intermodal transport container before transporting the proppant to the well site.

13. An apparatus for bulk transport of proppant comprising:
an intermodal transport container at a well site, the intermodal transport container having four vertical walls, a roof, and a base, defining an enclosed interior, proppant being loosely disposed within the enclosed interior; and
one or more gates in the intermodal transport container for unloading the proppant.

14. The apparatus of claim 13 in which the intermodal transport container further comprises a liner, within the enclosed interior, that conforms to the four vertical walls, the roof, and the base.

15. The apparatus of claim 14 in which the liner has a port in an upper portion of the liner for loading proppant into the liner.

16. The apparatus of claim 15 in which the port has a zipper.

17. The apparatus of claim 14 in which the one or more gates comprise one or more rear gates and further comprising a container tilter in support of the intermodal transport container.

18. The apparatus of claim 17 in which a rear wall of the intermodal transport container defines the one or more rear gates and further comprising two or more rigid support members spanning the rear wall in support of the liner.

19. The apparatus of claim 17 further comprising a proppant transfer device positioned to receive proppant unloaded from the one or more rear gates of the intermodal transport container.

20. The apparatus of claim 19 further comprising a mountain mover connected to receive proppant from the proppant transfer device.

21. The apparatus of claim 19 in which the proppant transfer device further comprises one or more of a hopper and a conveyor.
